(19) United States
(12) Patent Application Publication
(10) Pub. No.: US 2023/0214641 A1
(43) Pub. Date: Jul. 6, 2023

(54) REINFORCEMENT LEARNING FOR DYNAMIC MULTI-DIMENSION GOALS

(71) Applicant: International Business Machines Corporation, Armonk, NY (US)

(72) Inventors: Sathya Santhar, Ramapuram (IN); Sridevi Kannan, Katupakkam (IN); Samuel Mathew Jawaharlal, Chennai (IN); Suvedhahari Velusamy, Irving, TX (US)

(21) Appl. No.: 17/568,020

(22) Filed: Jan. 4, 2022

(51) Int. Cl. G06N 3/08; G06N 7/00

(52) U.S. Cl. CPC G06N 3/08; G06N 7/005

(57) ABSTRACT

An approach for state-based dynamic multi-dimensional goal reinforcement learning may be provided. The approach may include measuring a reward for an action. The reward may be a dimensional vector of a number of sub-goal dimensions for achieving a final goal. The approach may also include, determining a temporal difference. The temporal difference can be the difference between the reward from an action taken in response to an immediately prior state and the measured reward. The approach may also include updating a Q-table for the action. Updating the Q-table can be based on the first state and the measured reward. Further, the approach may also include predicting a goal for a first state. The prediction can be based on a Q-value from the updated Q-table. Within the approach, the prediction can be based on a deep neural network configured to output a probability.

### BACKGROUND OF THE INVENTION

The present invention relates generally to the field of machine learning, more specifically, to training a reinforcement learning model towards dynamic multi-dimensional goals based on state.

Reinforcement learning is a subfield of machine learning. In reinforcement learning, a reward is provided when an agent or model takes suitable actions in response to a particular situation or state. It can be viewed as a semi-supervised learning mode in which it does not rely solely on labelled training data but is not unsupervised because a reward is provided which the agent is configured to maximize. In reinforcement learning, a model or algorithm acts as an actor. The actor evaluates the current state or situation and takes an action. A reward is provided to the action and a new state is created by the action.

An overarching goal in reinforcement learning is to define the best sequence of decisions or actions that will allow an agent to address a state with an action, while maximizing the long-term reward. This is present in numerous applications in which an agent may be presented with numerous states, but not all the states have the same goal. Increasing the overall reward through numerous actions requires an exploratory approach to seek out new data and rewards, while still continuing to provide actions that are suitable for the observed state.

### SUMMARY

Embodiments of the present disclosure include a computer-implemented method, computer program product, and a system for state-based dynamic multi-dimensional goal reinforcement learning. Embodiments may include measuring a reward for an action, wherein the reward is a dimensional vector of a number of sub-goal dimensions for achieving a final goal. Embodiments may also include, determining a temporal difference, wherein the temporal difference is the difference between the reward from an action taken in response to an immediately prior state and the measured reward. Embodiments may also include, updating a Q-table for the action based on the first state and the measured reward. Additionally, embodiments may also include predicting a goal for a first state, based at least in part on a Q-value from the updated Q-table, wherein the prediction is based on a deep neural network configured to output a probability.

The above summary is not intended to describe each illustrated embodiment of every implementation of the present disclosure.

### BRIEF DESCRIPTION OF THE DRAWINGS

FIG. 1 is a functional block diagram generally depicting a state-based dynamic multi-dimensional goal reinforcement learning system 100, in accordance with an embodiment of the present invention.

FIG. 2 is a diagram generally depicting dynamic multi-goal reinforcement learning engine 104, generally designated 200, in accordance with an embodiment of the present invention.

FIG. 3 is a flowchart depicting a method for state-based dynamic multi-dimensional goal reinforcement learning 300, in accordance with an embodiment of the present invention.

FIG. 4 is a functional block diagram of an exemplary computing system 10 within state-based dynamic multi-dimensional goal reinforcement learning system, in accordance with an embodiment of the present invention.

FIG. 5 is a diagram depicting a cloud computing environment, in accordance with an embodiment of the present invention.

FIG. 6 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The embodiments depicted provide for an approach for state-based probability dynamic multi-dimensional goal reinforcement learning. Conventional reinforcement learning can only perform a single task and cannot scale to problems for which an agent needs to perform multiple tasks. Sometimes complex real world tasks may have no proximate nexus and are unrelated to each other. Existing reinforcement learning techniques find optimal policies for the multi-dimensional problems and combine the policies into a single policy for the composite task. This approach does not optimize the policies separately and tend not to perform when merged as a composite solution, due to interdependencies existing between diverse goals that require separate optimized policies and a generalized reward function.

Embodiments of the current invention may have improvements over prior technologies by maximizing the reward under the current environment. Embodiments may include focusing on a preferred end goal based on the distance to an end goal, which can change at each different state. In scenarios involving diverse end goals, embodiments may continue to update the end goal based on the distance from the current state, so the best possible end goal is reached in an optimal manner.

In an embodiment, an intelligent agent may attempt new actions in response to a state. A state is a current situation facing an intelligent agent. An intelligent agent is an algorithm or model that is configured to take specific actions in response to a state. The intelligent agent may change the end goal dynamically at each state based on the nearest goal. For example, in response to a state, there may be a predetermined set of actions (e.g., 1, 2, n...n+1) that the intelligent agent can perform. The intelligent agent may have diverse goals which are provided and factors for the goals which can vary with each new state. The intelligent agent can predict which action achieves a goal by determining which action will place it closest to one of the provided goals. The intelligent agent can update the actions and the end goals accordingly once the action has been verified and taken and a new state is achieved.

Embodiments may include building a Q-table for all the actions and states. For example, a Q-table may include n columns, where n = the number of actions. The table may include m rows, where m = the number of states. The current state can be observed by the agent and the agent can look up the potential actions for the observed state.

In an embodiment, the intelligent agent may pick an action for each provided sub-goal. A sub-goal is a factor that is provided for each end goal. For example, a sub goal could be timeliness, cost, available resources, etc. The intelligent agent may choose the action with the highest Q-value, while balancing exploration and exploitation. For example, the epsilon greedy search algorithm may be used to determine the action with the highest Q-value. A Q-value may be a multidimensional vector value that can be updated by the intelligent agent at each new state.

In an embodiment, the intelligent agent may select the action whose vector value outcome is the closest to the final goal vector value. For example, there may be four provided end goals (e.g., G1, G2, G3, and G4). In the current scenario, there are five potential actions that can be taken in response to the current state, in which action M3 produces the lowest angle difference to a predetermined goal. The intelligent agent can take the action M3 and update the current state to reflect that action.

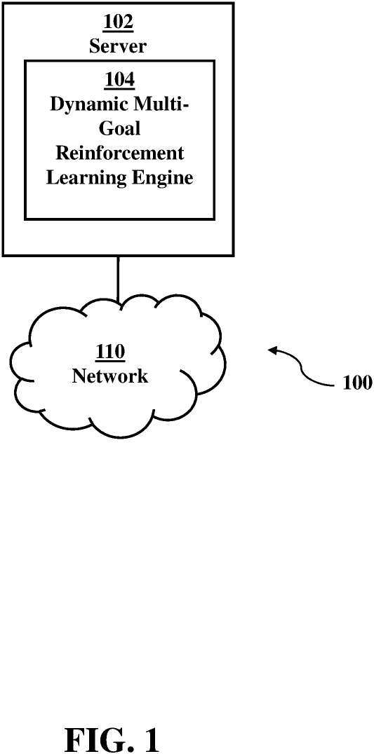

FIG. 1 is a functional block diagram generally depicting state-based dynamic multi-dimensional goal reinforcement learning system 100. State-based dynamic multi-dimensional goal reinforcement learning system 100 comprises dynamic multi-goal reinforcement learning engine 104 operational on server 102, and network 110.

Server 102 can be a standalone computing device, a management server, a web server, a mobile computing device, or any other electronic device or computing system capable of receiving, sending, and processing data. In other embodiments, server 102 can represent a server computing system utilizing multiple computers as a server system. In another embodiment, server 102 can be a laptop computer, a tablet computer, a netbook computer, a personal computer, a desktop computer, or any programmable electronic device capable of communicating with other computing devices (not shown) within state-based dynamic multi-dimensional goal reinforcement learning system 100 via network 110.

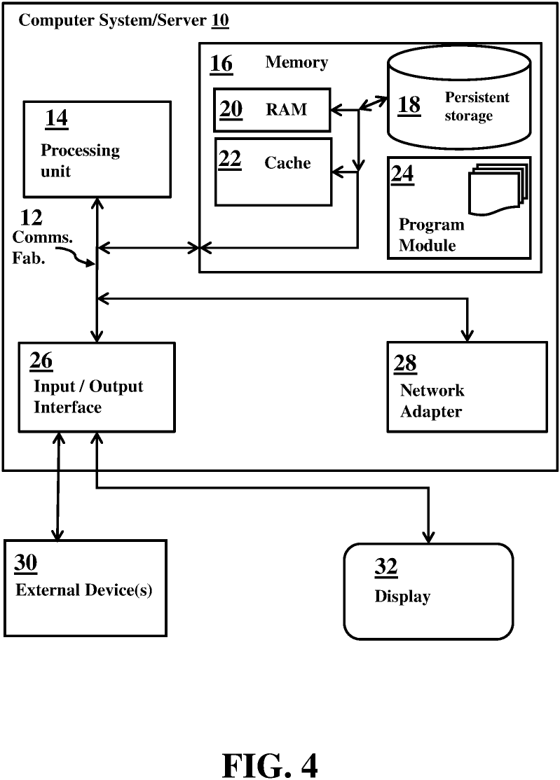

In another embodiment, server 102 represents a computing system utilizing clustered computers and components (e.g., database server computers, application server computers, etc.) that can act as a single pool of seamless resources when accessed within state-based dynamic multi-dimensional goal reinforcement learning system 100. Server 102 can include internal and external hardware components, as depicted and described in further detail with respect to FIG. 4. It should be noted, while only Server 102 is shown in FIG. 1, multiple computing devices can be present within state-based dynamic multi-dimensional goal reinforcement learning system 100. In an example, server 102 can be a part of a cloud server network in which a computing device (not shown) connected to network 110 can access server 102 (e.g., the internet).

Dynamic multi-goal reinforcement learning engine 104 is a computer program that can dynamically optimize a model for multiple goals in response to the current state. In an embodiment, dynamic multi-goal reinforcement learning engine 104 can act as an intelligent agent which can determine which action is best in response to a current state, while continuing to work towards an ultimate end goal.

Network 110 can be a local area network (LAN), a wide area network (WAN) such as the Internet, or a combination of the two, and can include wired, wireless, or fiber optic connections. In general, network 110 can be any combination of connections and protocols that will support communications between server 102 and other computing devices (not shown).

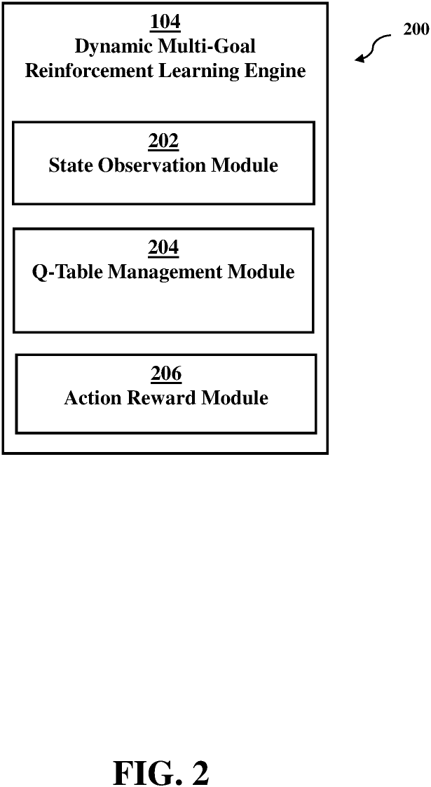

FIG. 2 is a functional block diagram 200 depicting dynamic multi-goal reinforcement learning engine 104. Shown operational on dynamic multi-goal reinforcement learning engine 104 is state observation module 202, Q-table management module 204, and action reward module 206.

State observation module 202 is a computer module that can be configured to observe the current environment and determine the state and actions that can be performed for that state. For example, state observation module 202 can observe that current state of a project via input from a user relating to progress or status of a project (e.g., package delivery, flight timeliness, video streaming, etc...). In another embodiment, state observation module 202 can determine the state based on multiple data points (temperature, network traffic, speed, etc...) from autonomous monitors in a system (e.g., electrical grid, self- driving vehicle, cloud server). Further, state observation module 202 can calculate a multi-dimensional vector value associated with the determined state.

State observation module 202 can find any actions that can be taken in response to the observed state. In an embodiment, if a state has been determined, state observation module 202 can have predetermined actions it can take in response to the state. For example, state observation module 202 can utilize a preconstructed Q-table and look up actions that can be taken in response to the determined state. In another example, state observation module 202 can dynamically determine an action to take in response to a determined state based on vector values associated with one or more known actions within a vector space. State observation module 202 can search the vector space nearby the determined state for a known action.

Q-table management module 204 is a computer module that can be configured to construct a Q-table and update a Q-table. In an embodiment, a Q-table is a table of multi-dimensional vector values, s, where there are n columns of actions and m columns of states. For example, for state Ml, there may corresponding s values in 8 columns for actions. This shows for state Ml, there are 8 actions that can be taken in response to the current state. Additionally, Q-table management module 204 can update the multi-dimensional vector values for actions undertaken in response to a reward determined by action reward module 206.

In an embodiment, Q-table management module 204 can construct a Q-table with all initial vector dimensional values at 0. Predetermined goals can be associated with the Q-table, where the dimensional vector values for the goals are assimilated and stored by Q-table management module 204. As training continues, reinforcement from action reward module 206 can cause Q-table management module 204 to associate specific states with the end goals due to the proximity of the values within the vector space. For example, Q-table management module 204 can update the Q-value of a previous state by using the temporal difference of the current state, action and Bellman’s equation as follows:

$${Q}_{t} \left(s , a\right) = {Q}_{t - 1} \left(s , a\right) + α \left(R \left(s , a\right) + γ {max}_{{a}^{1}} Q \left({s}^{′} , {a}^{′}\right) - {Q}_{t - 1} \left(s , a\right)\right)$$

where Q is the Q-value, t is the time step, s is the state, a is the action, α is the learning rate (dynamically set or static), R is the reward, and γ is the discount factor.

Action reward module 206 is a computer module that can be configured to undertake an action identified by state observation module 202 in response to an observed state. For example, if a model has multiple identified sub goals and a final goal, action reward module 206 can select the best action and undertake the action, resulting in a new state. The best action is the action whose vector value outcome is closest to the final goal vector value. Further, the action value which produces the lower angle difference between the corresponding Q-value and the final vector value should be selected as the optimal action.

In an embodiment, action reward module 206 can perform the selected action for each sub-goal and observe the reward, r, and the new state’s multi-dimensional vector value. A reward can be obtained as a dimensional vector value, where the vector value is the number of sub-goal dimensions defined for achieving the final goal. Additionally, action reward module 206 can measure the reward for the action taken in response to an immediately prior state to determine the vector value reward.

In an embodiment, action reward module 206 can have a deep neural network model associated with it, where the deep neural network can find the best goal for the observed state. For example, action reward module 206 can predict which end goal is nearest to the given input of action pairs. The model can be configured with each goal as the end nodes and a softmax layer as the final layer. The softmax layer can provide the probability for each goal given the action pair. The goal with the highest end probability from all action pair inputs for the state will be chosen as the end goal. In other words, the end goal can be verified by the deep neural network to check if the previously selected goal for the prior state is still the nearest goal, or if any other end goals are nearer to the action.

In an embodiment, action reward module 206 can be configured to adjust the reward for the goals. For example, if an action pair is provided an a different goal than previously selected for in the prior state is nearer, action reward module 206 can provide a higher reward value for selecting the different goal. Action reward module 206 can provide the updated Q-value to Q-table management module 204. In another example, at a second state s = 2, the second goal (G2) is found to be closer to the current state than the previously selected goal (G1). Action reward module 206 updates the Q-table to reflect that G2 is the overall end goal for the second state.

In an embodiment, action reward module 206 can select an action for the given state using an algorithm to search the vector space for the nearest goal provided an action pair. For example, action reward module 206 can utilize epsilon greedy search algorithm. Epsilon greedy search algorithm is an algorithm which searches and chooses the action with the highest Q value from the Q table, while balancing exploration and exploitation.

For example, the best action for the given state is the one whose vector value outcome is closest to the final goal vector value, or in other words, the optimal action is the one which produces the lowest angle difference between the corresponding Q-value and the final vector. The value can be determined as follows:

$${Q}_{m a x} = min \left({\sum }_{i = 0}^{n} min {\sum }_{j = 0}^{m} {\text{θ}}_{i j}\right)$$

where Qₘₐₓ is the highest Q value obtained from all the possible actions. θᵢⱼ is the angle between the interdependent multi-dimensional Q value calculated for the given state action pair and the final optimal Q-value, which is the target, n is the number of actions for the given state, and m is the number of interdependent goals.

In an embodiment, action reward module 206 can utilize a deep neural network to estimate the Q-values for each state-action pair in a given environment, and in turn, the network will approximate the optimal Q-function. The act of combining Q-learning with a deep neural network is called deep Q-learning, and a deep neural network that approximates a Q-function is called a deep Q-Network, or DQN.

In an embodiment, action reward module 206 can provide an additional optimized goal selection reward when a goal is chosen that is different than the goal chosen in the immediately prior state. For example, if G1 was chosen in the prior state and G3 is chosen in the current state for the action pair, an additional reward can be granted for finding an optimal path towards a new goal. This can continue throughout multiple iterations of training in such a way that the end goal continues to dynamically change at each state based on the distance of the goals from the current state.

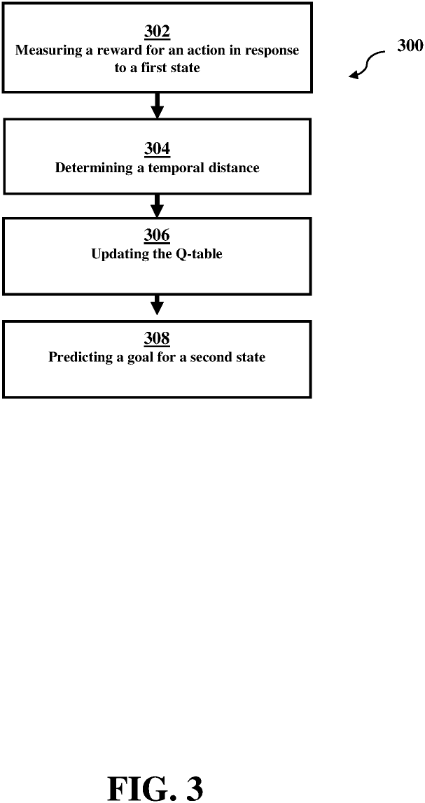

FIG. 3 is a flowchart depicting method 300 for state-based dynamic multi-dimensional goal reinforcement learning, in accordance with an embodiment of the present invention. At step 302, action reward module 206 can measure a reward for a selected action in response to a first state observed by state observation module 202. At step 304, action reward module 206 can determine a temporal distance of the observed state from the previous state and an identified action. At step 306, Q-table management module 204 can update the Q-values of the states and actions based on the temporal distance. At step 308, action reward module 206 can predict a goal for the observed state based on the update Q-values.

FIG. 4 depicts computer system 10, an example computer system representative of server 102 or any other computing device within an embodiment of the invention. Computer system 10 includes communications fabric 12, which provides communications between computer processor(s) 14, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Computer system 10 includes processors 14, cache 22, memory 16, network adaptor 28, input/output (I/O) interface(s) 26 and communications fabric 12. Communications fabric 12 provides communications between cache 22, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses or a crossbar switch.

Memory 16 and persistent storage 18 are computer readable storage media. In this embodiment, memory 16 includes persistent storage 18, random access memory (RAM) 20, cache 22 and program module 24. In general, memory 16 can include any suitable volatile or non-volatile computer readable storage media. Cache 22 is a fast memory that enhances the performance of processors 14 by holding recently accessed data, and data near recently accessed data, from memory 16. As will be further depicted and described below, memory 16 may include at least one of program module 24 that is configured to carry out the functions of embodiments of the invention.

The program/utility, having at least one program module 24, may be stored in memory 16 by way of example, and not limiting, as well as an operating system, one or more application programs, other program modules, and program data. Each of the operating systems, one or more application programs, other program modules, and program data or some combination thereof, may include an implementation of a networking environment. Program module 24 generally carries out the functions and/or methodologies of embodiments of the invention, as described herein.

Program instructions and data used to practice embodiments of the present invention may be stored in persistent storage 18 and in memory 16 for execution by one or more of the respective processors 14 via cache 22. In an embodiment, persistent storage 18 includes a magnetic hard disk drive. Alternatively, or in addition to a magnetic hard disk drive, persistent storage 18 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Network adaptor 28, in these examples, provides for communications with other data processing systems or devices. In these examples, network adaptor 28 includes one or more network interface cards. Network adaptor 28 may provide communications through the use of either or both physical and wireless communications links. Program instructions and data used to practice embodiments of the present invention may be downloaded to persistent storage 18 through network adaptor 28.

I/O interface(s) 26 allows for input and output of data with other devices that may be connected to each computer system. For example, I/O interface 26 may provide a connection to external devices 30 such as a keyboard, keypad, a touch screen, and/or some other suitable input device. External devices 30 can also include portable computer readable storage media such as, for example, thumb drives, portable optical or magnetic disks, and memory cards. Software and data used to practice embodiments of the present invention can be stored on such portable computer readable storage media and can be loaded onto persistent storage 18 via I/O interface(s) 26. I/O interface(s) 26 also connects to display 32.

Display 32 provides a mechanism to display data to a user and may be, for example, a computer monitor or virtual graphical user interface.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

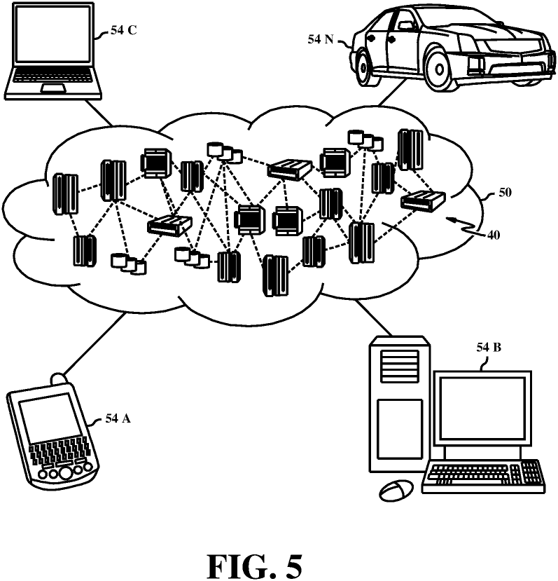

FIG. 5 is a block diagram depicting a cloud computing environment 50 in accordance with at least one embodiment of the present invention. Cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

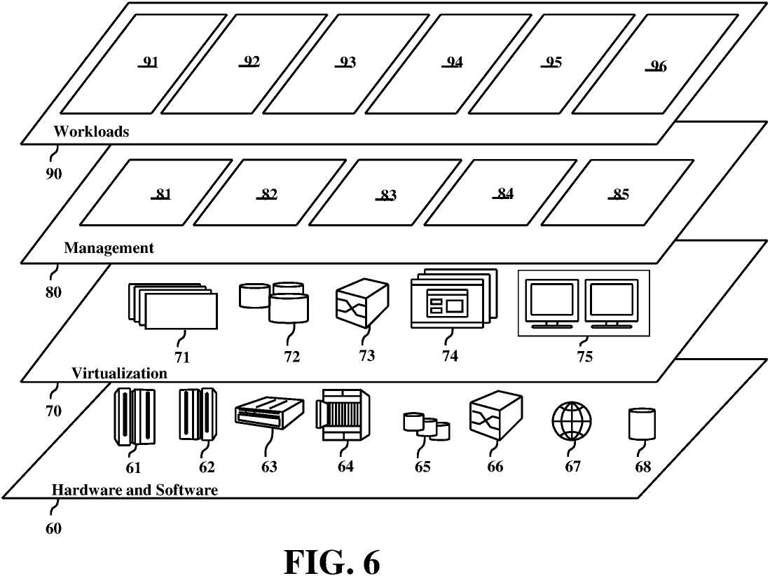

FIG. 6 is a block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and reinforcement learning for dynamic multi-dimension goals 96.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for state-based dynamic multi-dimensional goal reinforcement learning, the method comprising:
measuring, by a processor, a reward for an action, wherein the reward is a dimensional vector of a number of sub-goal dimensions for achieving a final goal;
determining, by the processor, a temporal difference, wherein the temporal difference is the difference between the reward from an action taken in response to an immediately prior state and the measured reward;
updating, by the processor, a Q-table for the action based on the first state and the measured reward; and
predicting, by the processor, a goal for a first state, based at least in part on a Q-value from the updated Q-table, wherein the prediction is based on a deep neural network configured to output a probability.

2. The computer-implemented method of claim 1, wherein selecting further comprises:
determining, by the processor, the action from the Q-table whose vector value outcome is closest to a final goal vector value.

3. The computer-implemented method of claim 1, wherein updating the Q-table further comprises:
determining, by the processor, a maximum reward for the state based, at least in part, on the temporal difference.

4. The computer-implemented method of claim 1, further comprising:
observing, by the processor, the state;
selecting, by the processor, the action to perform from a plurality of actions in the Q-table based on the state; and
performing, by the processor, the selected action.

5. The computer-implemented method of claim 1, further comprising:
initializing, by the processor, the Q-table, wherein the Q-table is comprised of a plurality of actions, a plurality of states, and a plurality of vector values corresponding to actions for each individual state.

6. The computer-implemented method of claim 1, further comprising:
providing, by the processor, an optimized goal selection reward based, at least in part, on the predicted goal for the state.

7. The computer-implemented method of claim 1, further comprising:
verifying, by the processor, the predicted goal, wherein verifying comprises calculating a dimensional vector distance from a state; and
selecting, by the processor, the predicted goal for the state.

8. A computer system for state-based dynamic multi-dimensional goal reinforcement learning, the system comprising:
a memory; and
a processor in communication with the memory, the processor being configured to perform operations comprising:
measure a reward for an action, wherein the reward is a dimensional vector of a number of sub-goal dimensions for achieving a final goal;
determine a temporal difference, wherein the temporal difference is the difference between the reward from an action taken in response to an immediately prior state and the measured reward;
update a Q-table for the action based on the first state and the measured reward; and
predict a goal for a first state, based at least in part on a Q-value from the updated Q-table, wherein the prediction is based on a deep neural network configured to output a probability.

9. The computer system of claim 8, wherein selecting further comprises operations to:
determine the action from the Q-table whose vector value outcome is closest to a final goal vector value.

10. The computer system of claim 8, wherein updating the Q-table further comprises operations to:
determine a maximum reward for the state based, at least in part, on the temporal difference.

11. The computer system claim 8, further comprising operations to:
observe the state;
select the action to perform from a plurality of actions in the Q-table based on the state; and
perform the selected action.

12. The computer system of claim 8, further comprising operations to:
initialize the Q-table, wherein the Q-table is comprised of a plurality of actions, a plurality of states, and a plurality of vector values corresponding to actions for each individual state.

13. The computer system of claim 8, further comprising operations to:
provide an optimized goal selection reward based, at least in part, on the predicted goal for the state.

14. The computer system of claim 8, further comprising operations to:
verify the predicted goal, wherein verifying comprises calculating a dimensional vector distance from a state; and
select the predicted goal for the state.

15. A computer program product for state-based dynamic multi-dimensional goal reinforcement learning, the computer program product comprising one or more computer readable storage devices and program instructions sorted on the one or more computer readable storage device, the program instructions executable by a processor to cause the processors to perform a function, the function comprising:
measure a reward for an action, wherein the reward is a dimensional vector of a number of sub-goal dimensions for achieving a final goal;
determine a temporal difference, wherein the temporal difference is the difference between the reward from an action taken in response to an immediately prior state and the measured reward;
update a Q-table for the action based on the first state and the measured reward; and
predict a goal for a first state, based at least in part on a Q-value from the updated Q-table, wherein the prediction is based on a deep neural network configured to output a probability.

16. The computer program product of claim 15, wherein selecting further comprises instructions to:
determine the action from the Q-table whose vector value outcome is closest to a final goal vector value.

17. The computer program product of claim 16, wherein updating the Q-table further comprises instructions to:
determine a maximum reward for the state based, at least in part, on the temporal difference.

18. The computer program product of claim 15, further comprising instructions to: observe the state;
select the action to perform from a plurality of actions in the Q-table based on the state; and
perform the selected action.

19. The computer program product of claim 15, further comprising instructions to:
initialize the Q-table, wherein the Q-table is comprised of a plurality of actions, a plurality of states, and a plurality of vector values corresponding to actions for each individual state.

20. The computer program product of claim 15, further comprising instructions to:
provide an optimized goal selection reward based, at least in part, on the predicted goal for the state.
